(19) United States
(12) Patent Application Publication
(10) Pub. No.: US 2005/0222967 A1
(43) Pub. Date: Oct. 6, 2005

(54) Periodic restructuring and repositioning of multi level marketing matrix hierarchy system

(76) Inventor: Micha Adir, Miami, FL (US)

Correspondence Address: MICHA ADIR, 7721 S.W. 61 AVENUE, MIAMI, FL, 33143, US

(21) Appl. No.: 10/818,260

(22) Filed: Apr. 4, 2004

(51) Int. Cl. G06F 7/00

(52) U.S. Cl. 707/1

(57) ABSTRACT

A software and database processing system provided for a Periodic Restructuring and Repositioning of Multi Level Marketing Participants Matrix Hierarchy (hereinafter referred as “PRMLM”)

### BACKGROUND

1. Field of Invention

This invention relates to the structuring of the hierarchy of a Multi Level Marketing (MLM) used by merchants to remunerate participants for the purchases made by the people that they directly or indirectly introduce for purchases and or services they buy or use. This definition of MLM covers all models where participants distribute products and or services or may not (whichever legal name(s) and status they are given to affiliates or called)

2. Description of Prior Art

In the past decade, the advancements of our computer age have been tremendous and the personal computer has integrated deep in our today's society throughout the entire world. More and more businesses have adopted this medium—the computer using the Internet to do business with computer users as the number of users increases from year to year. As a result of these developments and the development of ADSL (Asynchronies Digital Subscriber Line) and cable technology, in the last few years alone, companies who adopted the MLM approach to increase sales and market their products and or services, doubled according to some analysts. More and more companies resorted to this marketing strategy, but with it the tarnished reputation of MLM have increased as well. The ill reputation of excess hype or exaggerated residual income to entice participants, disillusioned many of those who seriously did and still do hope to achieve success in this business. Many companies enjoy tremendous growth as the years go by using MLM as a mean of distributing their product/service, and with it the number of dissatisfied and burnout participants are on the rise as well. Many participants suffered loss of initial investments such a starter kit and or engaged in a required monthly purchase of products often they can never possibly use month after month, ended up giving these items to relatives or close friend (if they are lucky to still have) and ended up in failure in the long run.

In an article written in April of 2002 by Gary E. Layton from http://thephantomwriters.com/free_content/w/l/whats_happening_n_mlm.shtml he wrote:

Quote

“Over the past two years a lot has happened to MLM on the Internet. The most obvious thing is that the old MLM systems are not working like they are supposed to. People are getting smarter and can recognize hype for hype and owner oriented profit schemes more easily.” End quote In the same article Mr. Layton also wrote:

Quote

“Let's face it, under the current rules being enforced by most of the regulatory agencies, paying for recruiting people is considered to be building a pyramid and that is a definite no-no. By law the majority of income from MLM's must result from the sales of products and services and not from recruiting people into the program.” End quote

His comments were made 4 years ago and fortunately, most people did get smarter through the years and are seeking to benefit from this industry remaining at their own homes conducting truly home base business whatever it may be. Today the recruiting method and hype to MLM is the ward “FREE” join for free. It is no longer “door to door” recruiting. It is “mouse to mouse” or “screen to screen” or “click to click”.

With the development of the MLM residual compensation plans the industry have developed numerous ways to stimulate and compensate their participants and various hierarchies have developed. However, in today's MLM industry we can classify all of the residual compensation plans and hierarchies to 3 basic types or categories that a company may adopt for their marketing strategy to compensate their distributors.
1. “Non Deferential”
2. “Stair-Step break Away (Semi Deferential)
3. “The Differential Continuous Compensation Plan or in short DCCP

All of above categories explained thoroughly in Patent # U.S. Pat. No. 6,421,648 (2002) which is the essence of its invention and the essence of category 3.

All the above scenarios have improved gradually to benefit both the company's marketing interest and the highly motivated recruiters in its own respective category. AU the above scenarios are still adhering to a structure hierarchy that is pointing down only. The emphasis is characteristic to all three categories—build your own down line together with your up line or on your own (See FIG. 1 please).

No matter how “we slice it” the above categories are still benefiting those who remain on top mostly. In the long run the above categories maintain the company's interest first in all cases but do not address the interests of the new corners and the entire structure outside of remunerating anyone who recruit aggressively in variety of ways.

The above categories 1, 2 and 3, fail to address the need of stimulating participation of those who are not all that motivated but yet can succeed and benefit by being an affiliated and consumers themselves.

Category 3, the DCCP patent skillfiilly and thoroughly explains the differential distribution in a mathematical equation but it is still one-way hierarchy at all times. It is the better of all the three and deserves praise in its development from a mathematical point of view.

Let us examine the following scenario. In an MLM hierarchy that adopts a 3 tier forced down, in the most lucrative scenario over 50% of the participants at the bottom hierarchy get very little or do not get compensated at any given monthly period. They are simply in a status of consumers only and get no reward for being such until they recruit someone under them, but yet they are there in a hope that someone else will help them and they wait and wait and after a year or so, they discover that they have hundreds or even thousands of recruits under them who were recruited for “free” but they are not purchasing any product or service. They are simply there in name and occupy positions in the hierarchy without generating residual income for those who are above them. So after a year the “dedicated affiliate” may have 3, 4, or 5 people under him/her who may be semi active, who are in the same predicament, who may generating some small amount of residual income for themselves. However by that time, they have invested hundreds of dollars in either products or services, which they may not need in the first place.

Below is a breakdown (Table 1) depicting seven generations 3 tiers forced down hierarchy. Each participant purchase a product for the amount of $50.00 multiplied by total participants of 1093 grosses the amount of $54,650.00. At a 130% margin of gross sales for the company, to be profitable, the total amount to be remunerated is 30% equals to $16,395.00. In a deferential compensation each tier of participants has a total group under them that is calculated in accord with the total percentage to be remunerated for each group and each participant in each levels total compensation and percentage of the overall hierarchy size is reflected below. This proves that in this scenario 67% of the participants at the bottom of the hierarchy get little or no compensation at any point of the hierarchy development. It is important to note that if not all the positions are filled in a less ideal scenario, the percentage of 0 residual income would be even higher.

TABLE 1

| 1^{st} | 2^{nd} | 3^{rd} | 4^{th} | 5^{th} | 6^{th} | 7^{th} | total pax | total $ |
|---|---|---|---|---|---|---|---|---|
| 1 | 3 | 9 | 27 | 81 | 243 | 729 | 1093 | 54,650.00 |
| 2,976.45 | 989.42 | 506.02 | 106.30 | 32.71 | 8.18 | 0 | | |
| 0.091% | 0.274% | 0.823% | 2.470% | 7.411% | 22.232% | 67% | 100% | 16,395.00 |
| 2,976.45 | 2,986.27 | 2,943.74 | 2,870.15 | 2,649.37 | 1,987.02 | | | |
| 18.155% | 18.105% | 17.955% | 17.506% | 16.160% | 12.12% | | | 16,395.00 |

The above scenario is the essence of patent #U.S. Pat. No. 6,421,648 (2002), which dealt with the mathematical explanation of the compensation invention, it explains the advantage of its invention in a mathematical equation over the other categories of “Non Deferential” and “Semi Deferential”. It may looks good in formula, but in reality it serves the interest of the company who sale the product or the service adopting MLM application and still maintaining the hierarchy growth downwards that benefit mostly the ones who are on top. The bigger the base becomes the less likely participants will remain and over 50% of the participants in a dynamic scenario are remained consumers without being remunerated until someone else takes their place by joining under their position and even then the compensation is minimal compared to the investment. As a result, a high attrition is inevitable to occur and constant recruiting efforts are needed to maintain the structure in tacked.

The following section is clarifying the advantageous idea presented, I named “Periodic Restructuring and Repositioning of Multi Level Marketing Matrix Hierarchy System” (PRMLM) which deals with the database repositioning and periodic restructuring applicable to any existing MLM in today's market and new ones to come. It includes the improvement essence for the main 3 categories I have mentioned earlier as well. It does not deal with calculation of compensation method per say; rather it suggests repositioning participants in the hierarchy for stimulating consumers and affiliates by occupying more lucrative positions periodically to help them become just as successful as those on top in today's market.

Objects and advantages

Periodic Restructuring and Repositioning Multi Level Marketing Matrix Hierarchy System” (PRMLM) is unique and effective in transforming “recruitments” to “participants” who are voluntarily eager to be affiliated consumers in this system since this PRMLM system performs a repositioning of the hierarchy structure locations of its participants. The simplicity brought by this application of PRMLM is driven so that the whole structure is periodically rotating around to favor even those who just join to become affiliated consumers and entered the hierarchy. Now, they can be just as successful as the savvy recruiter. Those who become affiliated consumers in this system program are fully aware that no selling skills are required, no pressure of recruiting are promoted. On the contrary, the motivation is solely by participation and consuming the product or service offered qualifies prospects to enter the repositioning motion of the hierarchy rotating positions periodically. Therefore, the structure hierarchy becomes a sharing residual distribution process.

(Please see FIGS. 4, 5, 6, and 7 examples of few possible options and in no way limited to these examples)

More specifically the Periodic Restructuring and Repositioning Multi Level Marketing Matrix Hierarchy System” (PRMLM) has the following advantages:

It fits any desirable combination of repositioning phase and designed to fit any combination hierarchy compensation MLM program plans such as, 3,4,5 or 6 front line tier forced down generations horizontally and vertically or any other format. It alters the present traditional MLM compensation program/system, which are presently working one way only—hierarchy downward at all times.

This system is going to foster participants to mutually increase the number of participants without adhering to “My Down Line” “Your Down Line”, and the whole hierarchy is becoming “Our Down Line and Up Line”. (Please see FIG. 2)

This PRMLM system program is designed to benefit everyone who becomes affiliated consumer particularly those who have entered prior to the scheduled specified restructuring period performed by the program and database.

This PRMLM system program encourages new participants to become consumers and join the program/system marketing venture voluntarily strictly on the merits and benefits of being part of this system, knowing that with-in giving time specified 30,60,90, 180 days or otherwise, the program/system will reposition its consumers affiliated participants and re-assign them to a position on the top of the hierarchy structure or down, depending upon their position, causing the structure to fluctuate and stimulate overall growth in the long run.

This PRMLM system program causes those who are at the initial stages and are at the top of the hierarchy during the first restructure period, to be the ones who undergo a reduction in compensation initially, but as many more restructuring periods proceed into the future, their position will balance to become handsomely rewarded which explained further below.

This PRMLM system program in the long run will revolutionize the way companies who choose MLM for marketing their product and or service to reward their affiliates and consumers and as a result, the sales/services production is inevitably will increase due to the merits of this invention.

This PRMLM system program will cause in a duration of several repositioning to attract many “burned out” MLM “dropouts” and retain the existing ones to remain customers/affiliates therefore, creating a low attrition to the hierarchy by repositioning them in the hierarchy to a position they would have never been able to achieve otherwise in a traditional MLM.

This PRMLM system program eliminates the factor of greed for it designed to create an equal opportunity compensation distribution fairly and justly.

This PRMLM system program eliminate the sale pressure and discomfort of recruiting new corners to this industry but rather create an opportunity atmosphere to be a participant for its revolutionary restructuring idea, which will attract new corners on its own merits. This PRMLM system program is designed to be able to assign a “Wild Card Position” (WCP) to any of the participant's position in the hierarchy matrix to achieve a desirable permanent position for certain participants who achieved a specific level of participation (Please see FIG. 8).

For the purpose of illustrating how this invention is working, the collection of drawings and tables below are gradually leading to illustrate a 4 months scenario of a Multi Level hierarchy that adopts a 3 tiers forced down hierarchy with 18 participants being added at each consecutive month, rotating and repositioning all participants positions as they are being added adopting the ⅓ rotation. At the end of the 4 months tables 6,7, and 8 are demonstrating that after 4 months and 3 rotations and repositioning periods, the percentage of those who have been remunerated increased by a significant amount compared to a hierarchy positions that remains static as it is in a traditional MLM.

This PRMLM system program complies with all federal and government regulatory laws and trade commissioned practices. It is designed to maintain equal opportunity to all involve in the marketing of products and services they promote.

### BRIEF DESCRIPTION OF THE DRAWINGS

FIG. 1

This figure illustrates a traditional Multi Level Marketing hierarchy

FIG. 2

This figure illustrates the new organized PRMLM hierarchy according to date and time of participants joining.

FIG. 3

This figure illustrates a complete reverse repositioning hierarchy and a continuation of placing new participants chronologically to the restructured hierarchy.

FIG. 4

This figure illustrates a circular schematic example of a complete rotation (1/1) a reversal hierarchy repositioning condition with 18 participants.

FIG. 5

This figure illustrates a circular schematic example of a ½-rotation hierarchy repositioning condition with 18 participants.

FIG. 6

This figure illustrates a circular schematic example of a ⅓-rotation hierarchy repositioning condition with 18 participants.

FIG. 7

This figure illustrates a circular schematic example of a ¼-rotation hierarchy repositioning condition with 20 participants.

FIG. 8

This figure illustrates a “Wilde Card Position” (WCP) granted to a position that bears 7 generations to a participant who is in the repositioning system the longest.

FIG. 9-1

This figure illustrates 3 tiers forced down hierarchy with 18 participants based on a ⅓-rotation repositioning.

FIG. 9-2

This figure illustrates a first month ⅓ rotation and repositioning a group of 18 participants.

FIG. 10-1

This figure illustrates 3 tiers forced down hierarchy with 36 participants based on a continuation of a ⅓ rotation and repositioning.

FIG. 10-2

This figure illustrates a second month ⅓ rotation and repositioning a group of 36 participants. FIG. 11-1

This figure illustrates 3 tiers forced down hierarchy with 54 participants based on a continuation of a ⅓ rotation and repositioning.

FIG. 11-2

This figure illustrates a third month ⅓ rotation and repositioning a group of 54 participants.

FIG. 12-1

This figure illustrates 3 tiers forced down hierarchy with 72 participants based on a continuation of a ⅓ rotation and repositioning.

FIG. 12-2

This figure illustrates a third month ⅓ rotation and repositioning a group of 72 participants.

FIG. 13

This figure illustrates a schematic process of PRMLM software and database interaction with the hierarchy positioning.

Tables

Table 1

This table depicts a compensation scenario of 3 tiers forced down hierarchy where more than 50% of the participants are consumers and do not get remunerated for being participants.

Table 2

This table depicts a first month scenario of 18 participants in a 3 tier forced down hierarchy being remunerated for a $50.00 purchase each month with overall 30% deferential compensation to participants.

Table 3

This table depicts the second month scenario of 36 participants in a 3 tier forced down hierarchy being remunerated for a $50.00 purchase each month with overall 30% deferential compensation to participants.

Table 4

This table depicts the third month scenario of 54 participants in a 3 tier forced down hierarchy being remunerated for a $50.00 purchase each month with over all 30% deferential compensation to participants.

Table 5

This table depicts the forth month scenario of 72 participants in a 3 tier forced down hierarchy being remunerated for a $50.00 purchase each month and over all 30% deferential compensation to participants.

Table 6

This table depicts the entire 4 months hierarchy being remunerated after a repositioning ⅓ rotation at each month adding 18 new participants at each consecutive month.

Tablet 7

This table depicts the entire above 4 months hierarchy sorted by the database chronologically to show who was remunerated and how much at each consecutive month.

Table 8

This table depicts the entire 4 months hierarchy scenario being remunerated with no rotations where the ones who are on top getting compensated the most.

### DETAILED DESCRIPTION OF DRAWING FIGURES AND TABLES

This invention is not limited to the following detailed figures and examples.

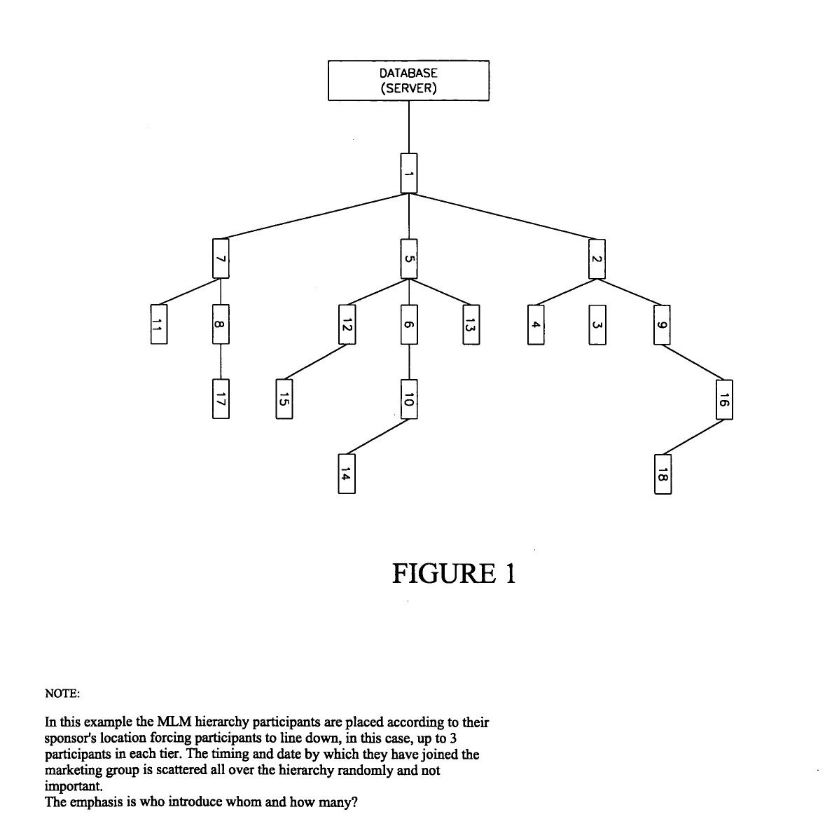

FIG. 1

In this figure the traditional MLM hierarchy participants are placed according to their sponsor's location forcing participants to line down, in this case, up to 3 participants in each tier. The timing and date by which they have joined the marketing group is scattered all over the hierarchy randomly. The emphasis is who introduce them and how many?

No. 1 through 18 depicts all the participants. No. 1 has under him/her three participants, 2,5, and 7. Those participants are placed under the person who introduced them. Although No. 7 and five came to the hierarchy after No. 3 they have been placed under their sponsor and not according to the time and date by which they entered the hierarchy. No. 2 has under him/her No. 9, 3 and 4. No. 4 and 9 are active participants who are purchasing a product or a service and generating residual income to the hierarchy above however, No. 3 is dormant and occupying a position without generating residual income.

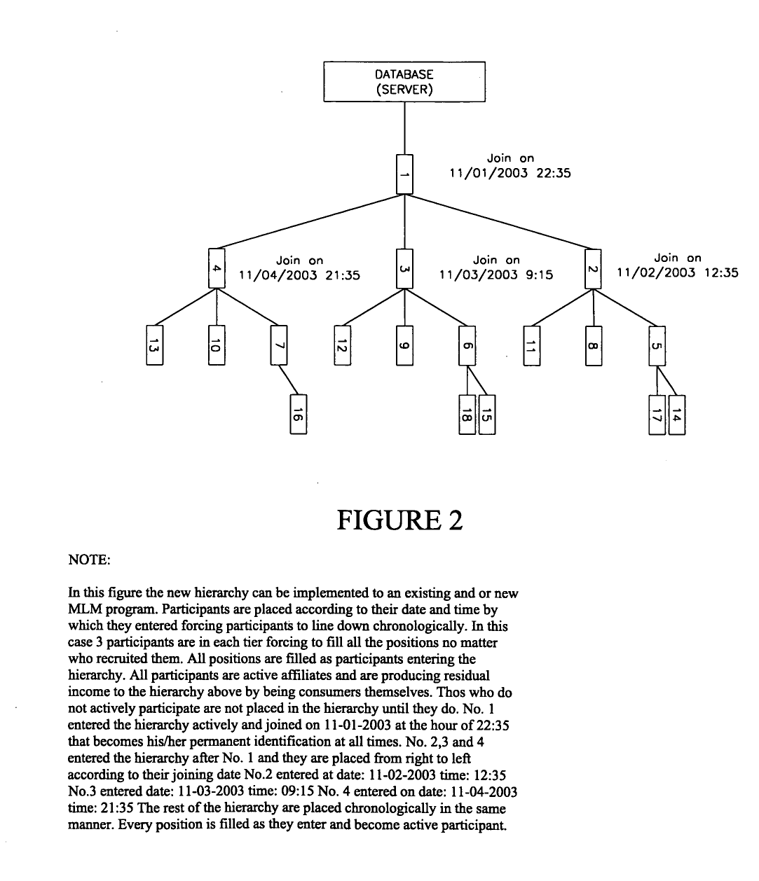

FIG. 2

In this figure the new hierarchy can be implemented to an existing and or new MLM program. Participants are placed according to their date and time by which they entered forcing participants to line down chronologically. In this case 3 participants are in each tier forcing to fill all the positions no matter who recruited them. All positions are filled as participants entering the hierarchy. All participants are active affiliates and are producing residual income to the hierarchy above by being consumers themselves. Thos who do not actively participate are not placed in the hierarchy until they do. No. 1 entered the hierarchy actively and joined on 11-01-2003 at the hour of 22:35 that becomes his/her permanent identification at all times (for simplicity it is given a number instead of date). No. 2,3 and 4 entered the hierarchy after No. 1 and they are placed from right to left spread equally to each tier one at the time which is done according to their joining date No. 2 entered at date: 11-02-2003 time: 12:35 No. 3 entered date: 11-03-2003 time: 09:15 No. 4 entered on date: 11-04-2003 time: 21:35 The rest of the hierarchy are placed chronologically in the same manner. Every position is filled as they enter and become active participants.

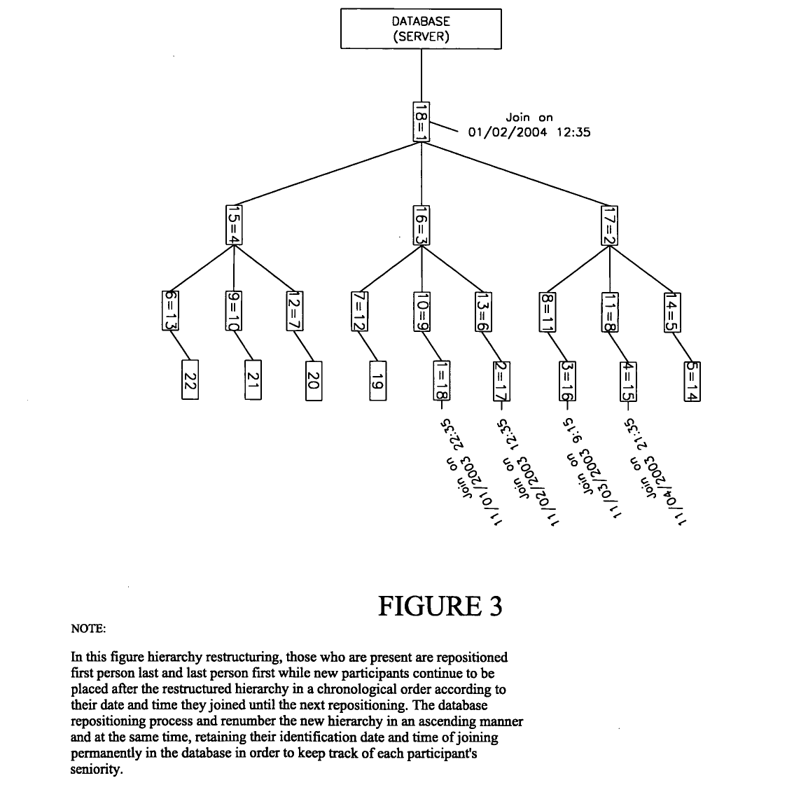

FIG. 3

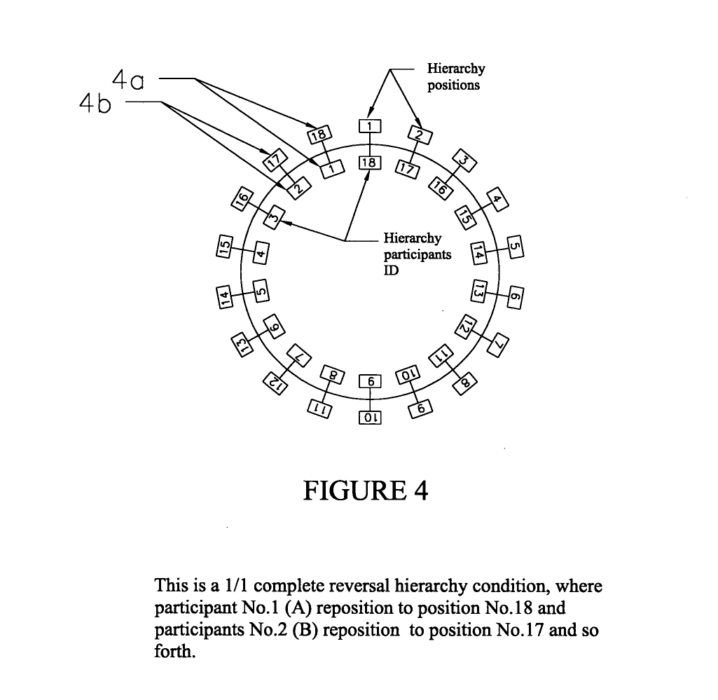

In this figure hierarchy restructuring, those who are present are repositioned first person last and last person first while new participants continue to be placed after the restructured hierarchy in a chronological order according to their date and time they joined until the next repositioning. The database repositioning process renumber the new hierarchy in an ascending manner and at the same time, retaining their identification date and time ofjoinmg permanently in the database in order to keep track of each participant's seniority. No. 18 repositioned to position 1. No. 17 repositioned to position 2. No. 16 repositioned to position 3. No. 15 repositioned to position 4. No. 14 repositioned to position 5. No. 13 repositioned to position 6. No. 12 is repositioned to position 7. No. 11 is repositioned to position 8. No. 10 is repositioned to position 9. No. 9 is repositioned to position 10. No. 8 is repositioned to position 11. No. 7 is repositioned to position 12. No. 6 is repositioned to position 13. No. 5 is repositioned to position 14. No. 4 is repositioned to position 15. No. 3 is repositioned to position 16. No. 2 is repositioned to position 17 and No. 1 is repositioned to position 18. The database continuing to place new participants in ascending manner 19,20, 21 22 and so forth until the next repositioning FIG. 4

This is a 1/1 circular schematic of a complete reversal hierarchy condition, where participant No. 1 (4a) repositioned to position 18, and participant No. 2 (4b) repositioned to position 17 and so forth.

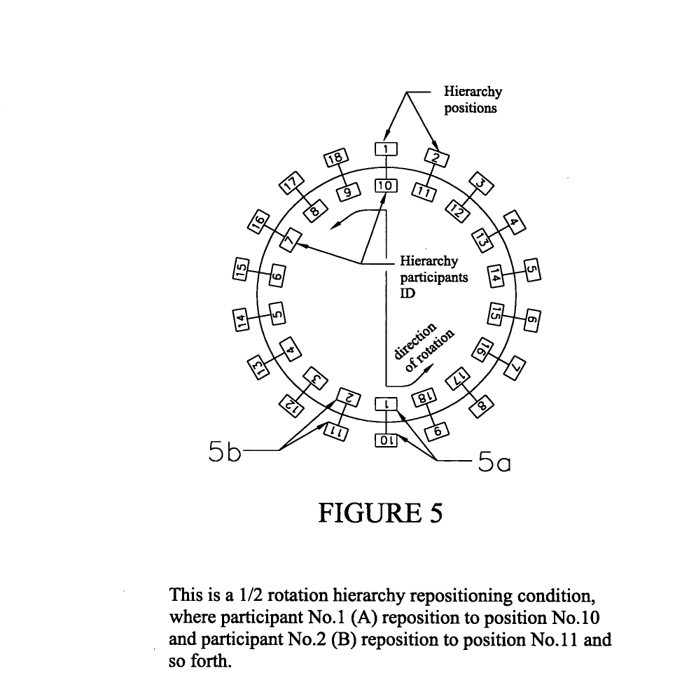

FIG. 5

This is a ½-circular schematic rotation of hierarchy repositioning condition, where participant No. 1 (5a) repositioned to position 10, and participant No. 2 (5b) repositioned to position 11 and so forth.

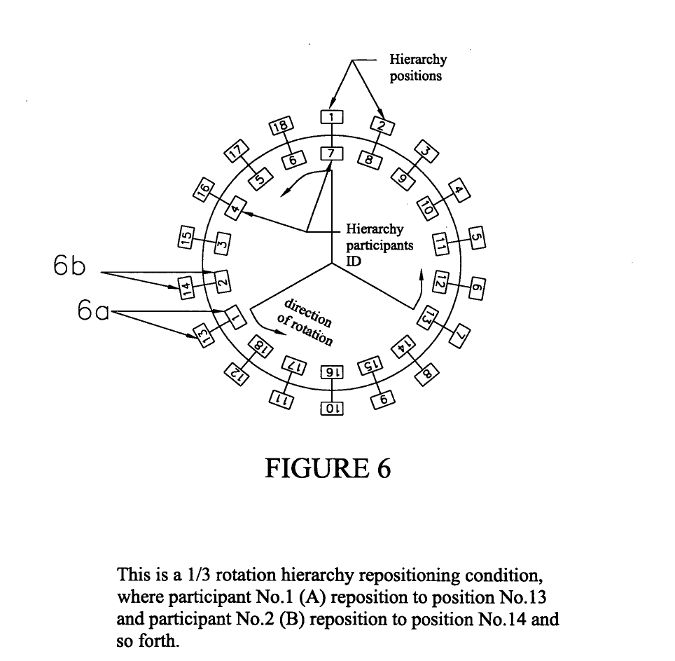

FIG. 6

This is a ⅓-circular schematic rotation of hierarchy repositioning condition, where participant No. 1 (6a) repositioned to position 13, and participant No. 2 (6b) repositioned to position 14 and so forth.

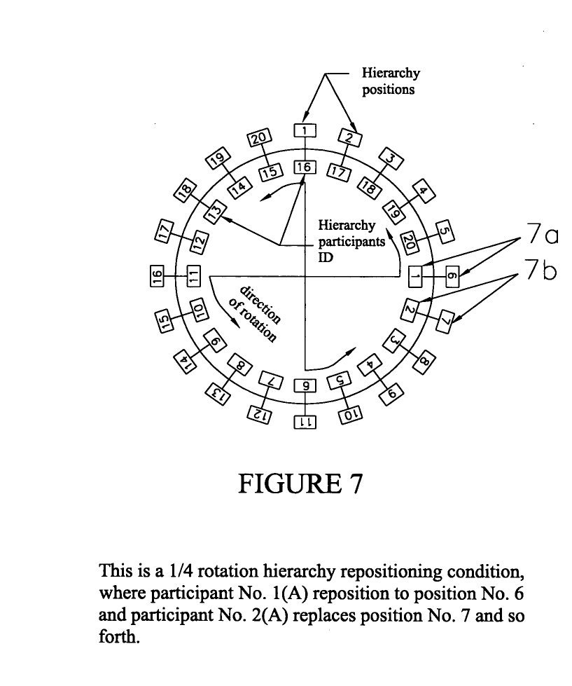

FIG. 7

This is a ¼-circular schematic rotation of hierarchy repositioning condition, where participant No. 1 (7a) is repositioned to position 6, and participant No. 2 (7b) is repositioned to position 7 and so forth.

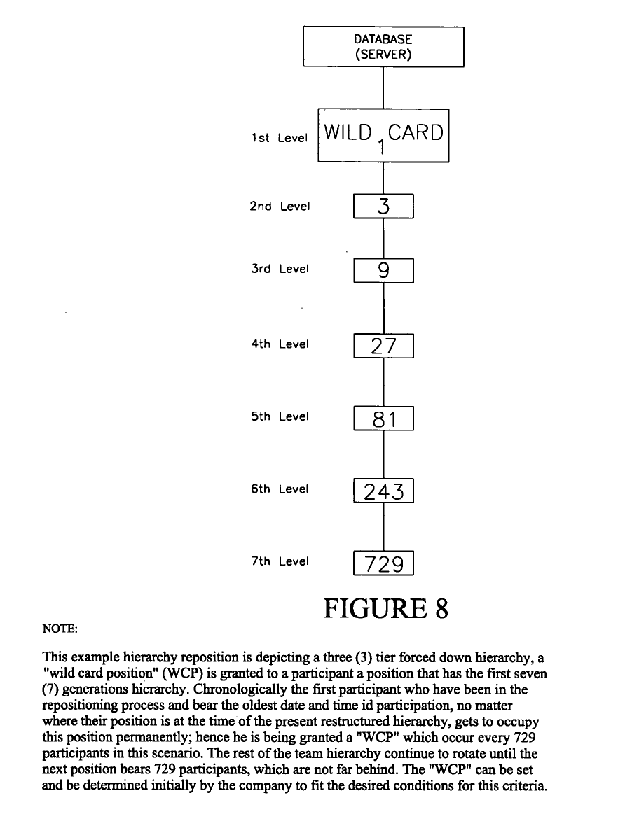

FIG. 8

This figure hierarchy reposition is depicting a 3 tier forced down hierarchy, a “Wild Card Position” (WCP) is granted to a participant a position that has the first 7 generations hierarchy. Chronologically the first participant who have been in the repositioning process and bears the oldest date and time identification participant, no matter where their position is at the time of the hierarchy restructure, he/she gets to occupy this position permanently hence he/she is being granted a WCP which occur every 729 participants in this case. The rest of the team hierarchy continuing to rotate positions until the next position bears 7 generations, which are not far behind. The granting criteria for a WCP can be set and determined initially by the company to fit the desired condition for this criterion. (Meaning how many generations are to be accumulated before WCP is granted)

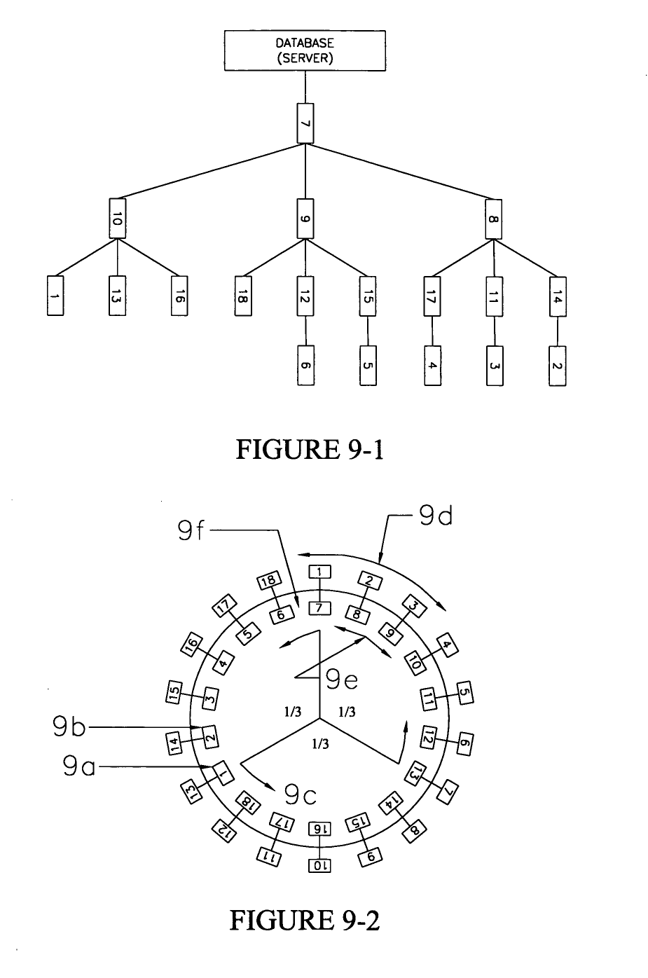

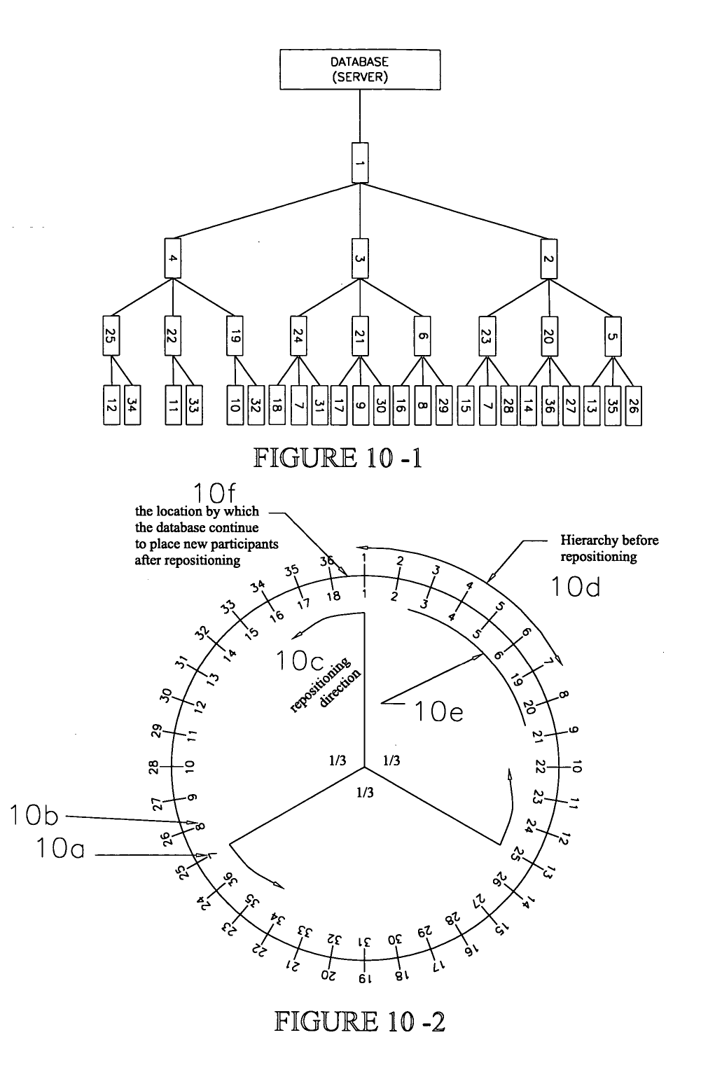

FIG. 9-1

This figure illustrates a first month ⅓ rotation and repositioning a group of 18 participants. This figure is implementing FIG. 9-2 a ⅓ circular rotation of participants into actual position in the hierarchy which participant No. 7 occupy the top position and Participant No. 6 occupy the bottom position.

FIG. 9-2

This figure illustrates a first month ⅓ rotation and repositioning a group of 18 participants. Participant No. 1 (9a) goes to position 13, and participant No. 2 (9b) goes to position 14 (9c) indicates the direction of rotation. (9d) indicates the chronological hierarchy positions depicted on the outer circle. (9e) indicates the participants identification number depicted on the inner circle. (9f) indicates the location by which the database continue to place new participants after repositioning period.

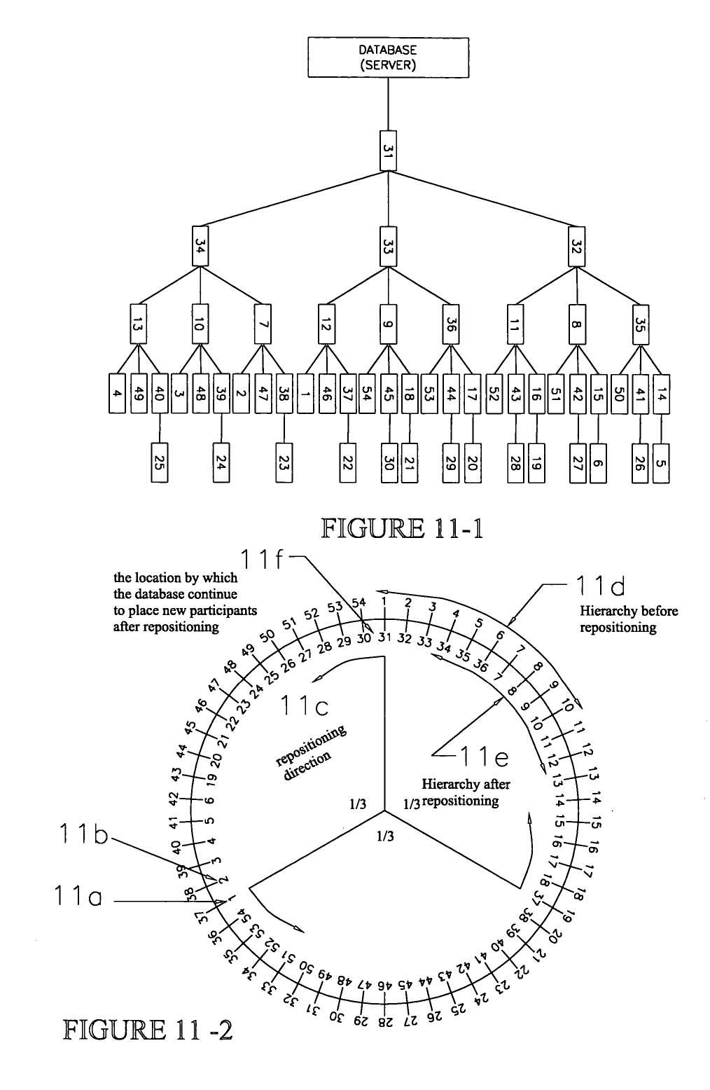

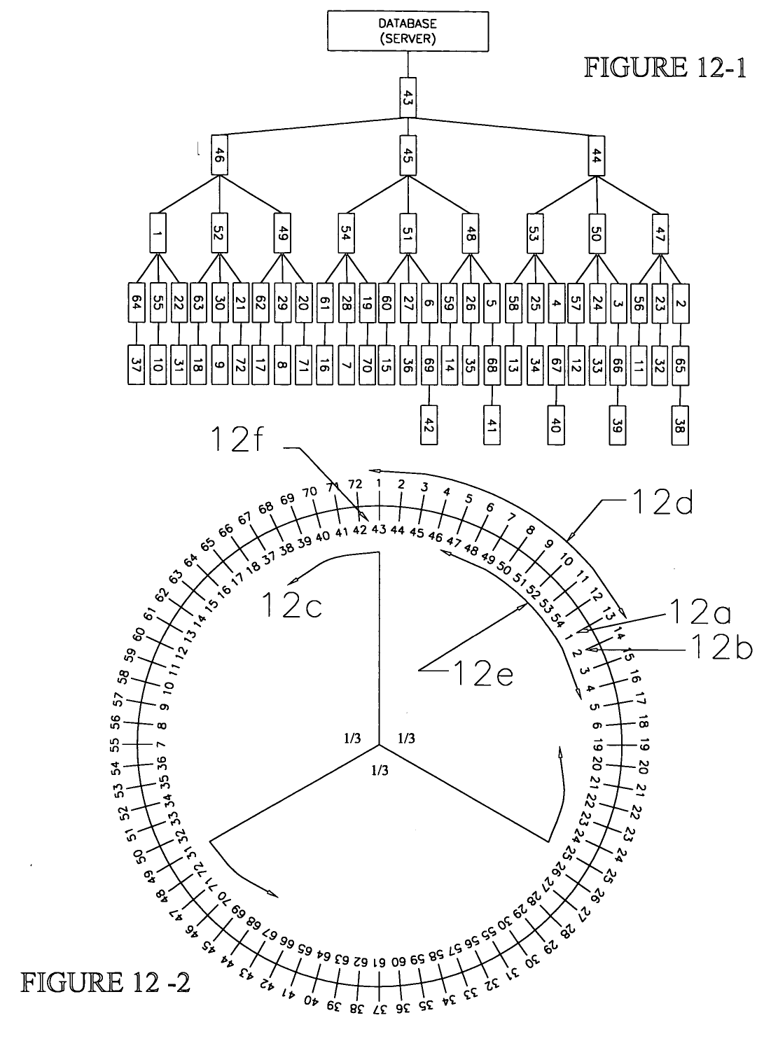

FIG. 10-1

This figure illustrates the second month ⅓ rotation and repositioning a group of 36 participants. This figure is implementing FIG. 10-2 a ⅓ circular rotation of participants into actual position in the hierarchy which number 25 occupy the top position and number 24 occupy the bottom position.

FIG. 10-2

This figure illustrates the second month ⅓ rotation and repositioning a group of 36 participants. Participant No. 1 (10a) goes to position 25, and participant No. 2 (10b) goes to position 26 (10c) indicates the direction of rotation. (10d) indicates the chronological hierarchy positions depicted on the outer circle. (10e) indicates the participants identification number depicted on the inner circle. (10f) indicates the location by which the database continue to place new participants after repositioning period.

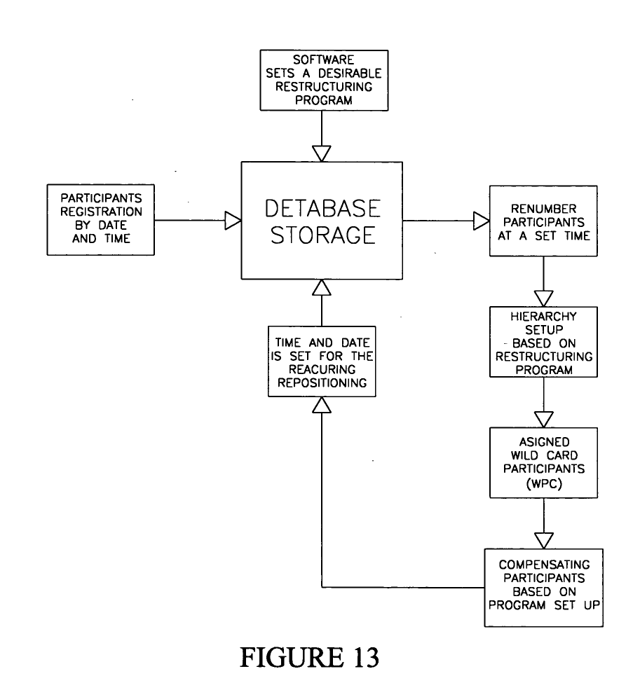

FIG. 11-1

This figure illustrates the third month ⅓ rotation and repositioning a group of 54 participants. This figure is implementing FIG. 11-2 a ⅓ circular rotation of participants into actual position in the hierarchy which No. 31 occupy the top position and No. 30 occupy the bottom position.

FIG. 11-2

This figure illustrates third month ⅓ rotation and repositioning a group of 54 participants. Participant No. 1 (11a) repositioned to position 37, and participant No. 2 (11b) repositioned to position 38 (11c) indicates the direction of rotation. (11d) indicates the chronological hierarchy positions depicted on the outer circle. (11e) indicates the participants identification number depicted on the inner circle. (11f) indicates the location by which the database continue to place new participants after repositioning period.

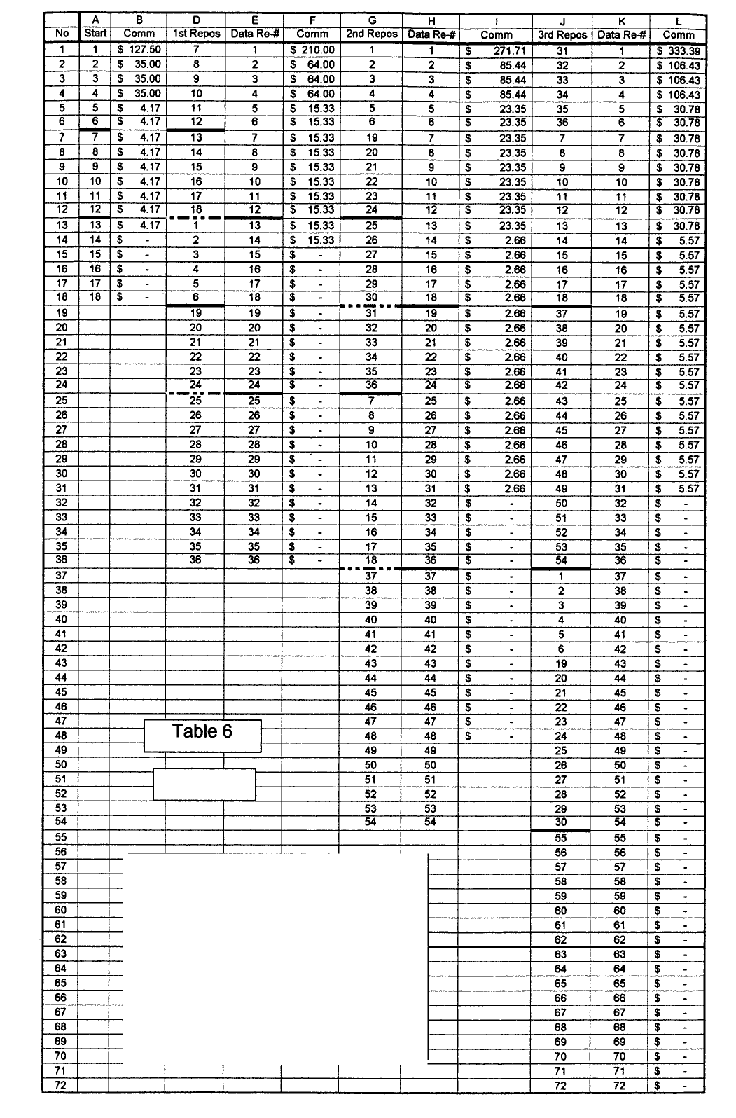

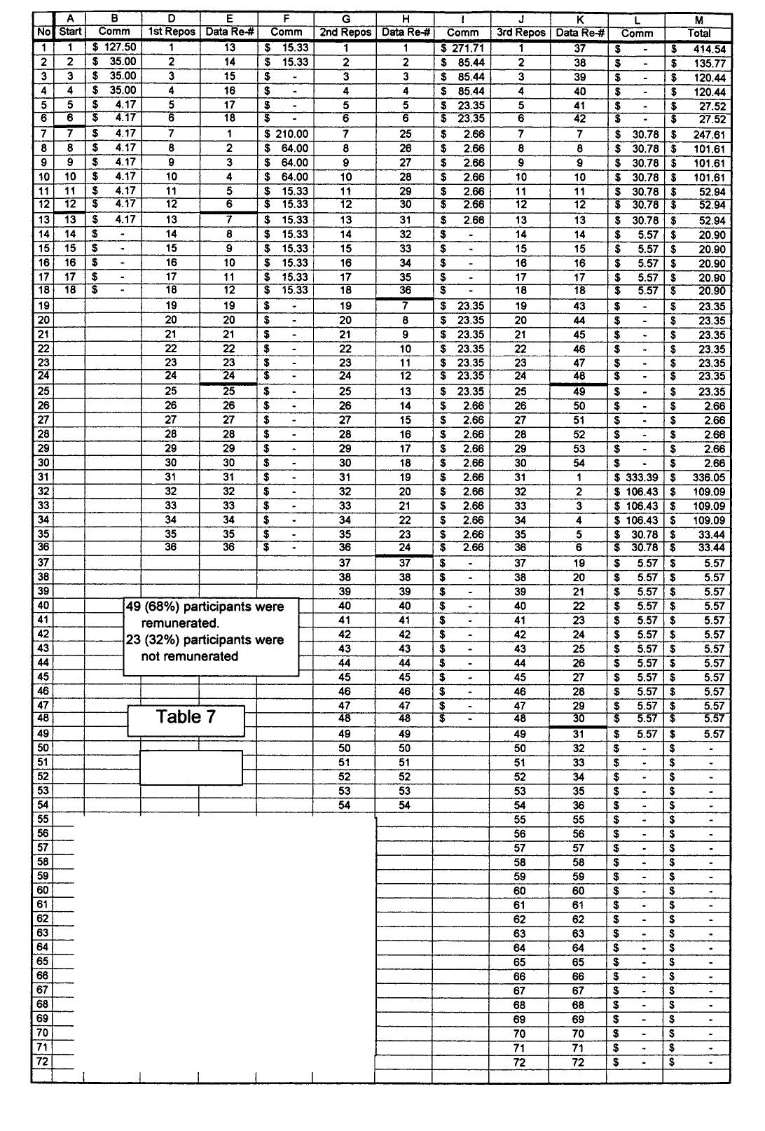

FIG. 12-1

This figure illustrates the forth month ⅓ rotation and repositioning a group of 72 participants. This figure is implementing FIG. 12-2 a ⅓ circular rotation of participants into actual position in the hierarchy which No. 43 occupy the top position and No. 42 occupy the bottom position.

FIG. 12-2

This figure illustrates forth month ⅓ rotation and repositioning a group of 72 participants. Participant No. 1 (12a) repositioned to position 13, and participant No. 2 (12b) repositioned to position 14 (12c) indicates the direction of rotation. (12d) indicates the chronological hierarchy positions depicted on the outer circle. (12e) indicates the participants identification number depicted on the inner circle. (12f) indicates the location by which the database continue to place new participants after repositioning period.

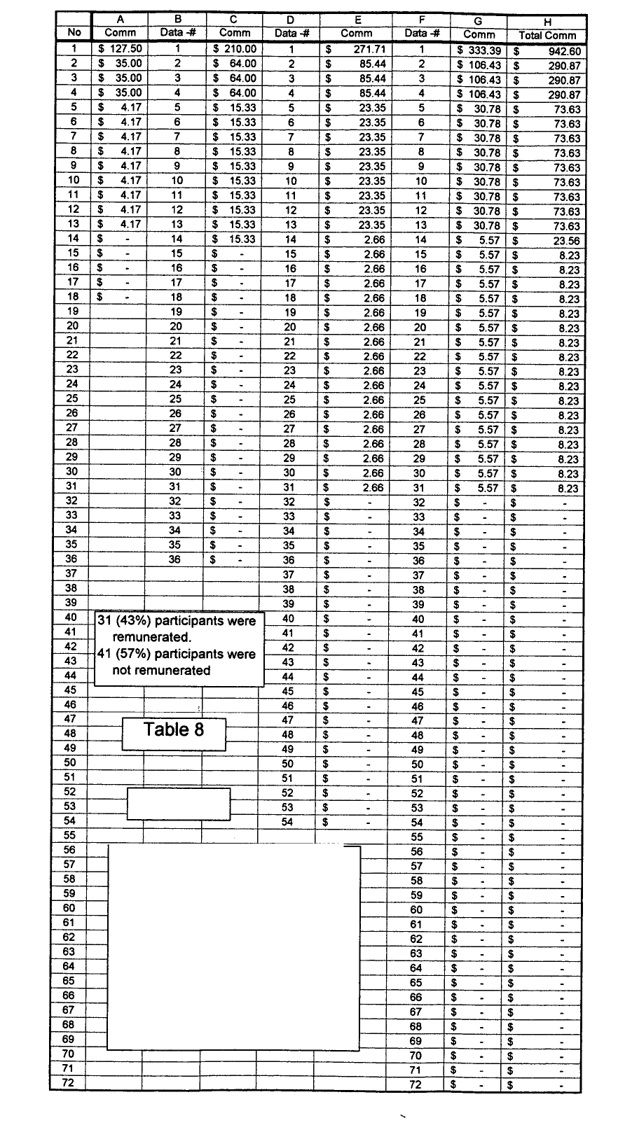

FIG. 13

This figure depicts in a block diagram the sequence of events that take place in the PRMLM database to achieve the desirable restructuring in a repeating cycle determined by the software program.

Tables

The following tables illustrate a 4 months participant's hierarchy accumulation and 3 periods of ⅓ hierarchy rotation repositioning with compensation based on 30% overall commission and a monthly purchase participation of $50.00 at a 3 tier hierarchy forced down. Each one of the 3 repositioning presented (for simplicity purpose), at each repositioning, 18 new participants are joining to illustration this scenario.

TABLE 2

| Gross company | Total affiliates | First level | Second level | Third level | Forth level | Fifth level |
|---|---|---|---|---|---|---|
| $ 900.00 | 18 | 1 | 3 | 9 | 5 | |
| Commission | Total groups | Total group 1 | Total group 2 | Total group 3 | Total group 4 | Total group 5 |
| $ 270.00 | 36 | 17 | 14 | 5 | 0 | 0 |
| % of Comm | Total comm | Total paid | Total paid | Total paid | Total paid | Total paid |
| 30% | $ 270.00 | $ 127.50 | $ 105.00 | $ 37.50 | $ — | 0 |
| Product | Total paid | Total each | Total each | Total each | Total each | Total each |
| $ 50.00 | $ 270.00 | $ 127.50 | $ 35.00 | $ 4.17 | $ — | 0 |
| Average Comm | Ave % a unit | Ave % each | Ave % each | Ave % each | Ave % each | Ave % each |
| $ 7.50 | 2.778% | 47.222% | 12.963% | 1.543% | 0.0000% | 0.0000% |
| Tier Hierarchy | Profit margin | Ave % group | Ave % group | Ave % group | Ave % group | Ave % group |
| 3 | 100% | 47.222% | 38.889% | 13.889% | 0.000% | 0.000% |

Table 2

The first month, this table is showing 18 total participants. The first level has 17 people in the group and this level has 1 person. The second level has 14 participants in the group and this level has 3 people. The third level has 5 participants in the group and this level has 9 people. The fifth level has no participants and this level has 5 people. The total participants are 18 and the total groups participants are 36. A $50.00 for this month purchase of each participant comes to a total of $900.00 at 30% compensation for the total participants of 18 people comes to $270.00 Divided by total groups of 36 gives the deferential commission of $7.50 and average percentage of 2.778%. First level consist of 17 participants in its group multiply the deferential commission of $7.50 totaling $127.50 for first level to 1 person. Second level consist of 14 participants multiplied by the deferential commission of $7.50 totaling $105.00 divided by 3 people in this level equals to $35.00 each. Third level has 5 participants multiplied by the deferential commission of $7.50 totaling $37.50, divided by 9 people in this level equals to $4.17 each. Forth level has 0 participants therefore has no compensation yet.

TABLE 3

| Gross company | Total affiliates | First level | Second level | Third level | Forth level | Fifth level |
|---|---|---|---|---|---|---|
| $ 1,800.00 | 36 | 1 | 3 | 9 | 23 | 0 |
| Commission | Total groups | Total group 1 | Total group 2 | Total group 3 | Total group 4 | Total group 5 |
| $ 540.00 | 90 | 35 | 32 | 23 | 0 | 0 |
| % of Comm | Total comm | Total paid | Total paid | Total paid | Total paid | Total paid |
| 30% | $ 540.00 | $ 210.00 | $ 192.00 | $ 138.00 | $ — | 0 |
| Product | Total paid | Total each | Total each | Total each | Total each | Total each |
| $ 50.00 | $ 540.00 | $ 210.00 | $ 64.00 | $ 15.33 | $ — | 0 |
| Average Comm | Ave % a unit | Ave % each | Ave % each | Ave % each | Ave % each | Ave % each |
| $ 6.00 | 1.111% | 38.889% | 11.852% | 2.840% | 0.0000% | 0.0000% |
| Tier Hierarchy | Profit margin | Ave % group | Ave % group | Ave % group | Ave % group | Ave % group |
| 3 | 100% | 38.889% | 35.556% | 25.556% | 0.000% | 0.000% |

Table 3

The second month, new additional 18 participants added to the hierarchy and it follows the same pattern of calculation to include 36 participants and 90 total in groups are being remunerated.

A $50.00 for this second month purchase of each participant comes to a total of $1800.00 at 30% compensation for the total participants of 36 people equals to $540.00 Divided by total in groups of 90 gives the deferential commission of $6.00 and average percentage of 1.111%.

The first level consists of 35 participants in its group multiplied the deferential commission of $6.00 totaling $210.00 for the first level to 1 person. Second level consists of 32 participants under them multiplied by the deferential commission of $6.00 totaling $192.00 divided by 3 people in this level equals to $64.00 each. Third level has 23 participants under them multiplied by the deferential commission of $6.00 totaling $138.00, divided by 9 people in this level equals to $15.33 each. Forth level has 0 participants under them therefore has no compensation yet.

TABLE 4

| Gross company | Total affiliates | First level | Second level | Third level | Forth level | Fifth level |
|---|---|---|---|---|---|---|
| $ 2,700.00 | 54 | 1 | 3 | 9 | 27 | 14 |
| Commission | Total groups | Total group 1 | Total group 2 | Total group 3 | Total group 4 | Total group 5 |
| $ 810.00 | 158 | 53 | 50 | 41 | 14 | 0 |
| % of Comm | Total comm | Total paid | Total paid | Total paid | Total paid | Total paid |
| 30% | $ 810.00 | $ 271.71 | $ 256.33 | $ 210.19 | $ 71.77 | 0 |
| Product | Total paid | Total each | Total each | Total each | Total each | Total each |
| $ 50.00 | $ 810.00 | $ 271.71 | $ 85.44 | $ 23.35 | $ 2.66 | 0 |
| Average Comm | Ave % a unit | Ave % each | Ave % each | Ave % each | Ave % each | Ave % each |
| $ 5.13 | 0.633% | 33.544% | 10.549% | 2.883% | 0.3282% | 0.0000% |
| Tier Hierarchy | Profit margin | Ave % group | Ave % group | Ave % group | Ave % group | Ave % group |
| 3 | 100% | 33.544% | 31.646% | 25.949% | 8.861% | 0.000% |

Table 4

The third month, new additional 18 participants are added to the hierarchy and it follows the same pattern of calculation to include 54 participants and 158 total in groups being remunerated.

A $50.00 for this third month purchase of each participants comes to a total of $2700.00 at 30% compensation for the total participants of 54 people comes to $810.00 Divided by total in groups of 158 gives the deferential commission of $5.13 and average percentage of 0.633%. First level consist of 53 participants under multiplied the deferential commission of $5.13 totaling $271.71 for the first level to 1 person. Second level consist of 50 participants under them multiplied by the deferential commission of $5.13 totaling $256.33 divided to 3 people in this level equals to $85.44 each. Third level has 41 participants under them multiplied by the deferential commission of $5.13 totaling $210.19, divided to 9 people in this level equals to $23.35 each. Forth level has 14 participants under them multiplied by the deferential commission of $5.13 equals to $71.77 divided to 27 people equals to $2.66. Fifth level has 0 participants under them therefore has no compensation yet.

TABLE 5

| Gross company | Total affiliates | First level | Second level | Third level | Forth level | Fifth level |
|---|---|---|---|---|---|---|
| $ 3,600.00 | 72 | 1 | 3 | 9 | 27 | 32 |
| Commission | Total groups | Total group 1 | Total group 2 | Total group 3 | Total group 4 | Total group 5 |
| $ 1,080.00 | 230 | 71 | 68 | 59 | 32 | 0 |
| % of Comm | Total comm | Total paid | Total paid | Total paid | Total paid | Total paid |
| 30% | $ 1,080.00 | $ 333.39 | $ 319.30 | $ 277.04 | $ 150.26 | 0 |
| Product | Total paid | Total each | Total each | Total each | Total each | Total each |
| $ 50.00 | $ 1,080.00 | $ 333.39 | $ 106.43 | $ 30.78 | $ 5.57 | 0 |
| Average Comm | Ave % a unit | Ave % each | Ave % each | Ave % each | Ave % each | Ave % each |
| $ 4.70 | 0.435% | 30.870% | 9.855% | 2.850% | 0.5153% | 0.0000% |
| Tier Hierarchy | Profit margin | Ave % group | Ave % group | Ave % group | Ave % group | Ave % group |
| 3 | 100% | 30.870% | 29.565% | 25.652% | 13.913% | 0.000% |

Table 5

The forth month, new additional 18 participants are added to the hierarchy and it follows the same pattern of calculation to included 72 participants and 230 total in groups being remunerated. A $50.00 for this forth month purchase of each participants comes to a total of $3600.00 at 30% compensation for the total participants of 72 people comes to $1080.00 Divided by total in groups of 230 gives the deferential commission of $4.70 and average percentage of 0.435%.

First level consist of 71 participants under him/her multiplied the deferential commission of $4.70 totaling $333.39 for the first level to 1 person. Second level consist of 68 participants under them multiplied by the deferential commission of $4.70 totaling $319.30 divided to 3 people in this level equals to $106.43 each. Third level has 59 participants under them multiplied by the deferential commission of $4.70 totaling $277.04, divided to 9 people in this level equals to $30.78 each. Forth level has 32 participants under them multiplied by the deferential commission of $4.70 equals to $150.26 divided to 27 people equals to $5.57 each. The fifth level has 0 participants under them therefore has no compensation yet.

Table 6

Shows the entire hierarchy being remunerated based on the above tables calculations. The purpose of this illustration is to show the monthly repositioning of three consecutive months rotating ⅓ of all participants while new ones are being added each month. In this example 18 new participants are joining each month and the rotation is being executed by the database in the following manner:

In the first month the hierarchy grows to 18 participants and each participant based on the calculations above receives the depicted amounts that show in column (B) based on table 2. At midnight at the end of the last day of that month the database is performing the first repositioning of all participants totaling in column E to become 18. This time the ⅓ rotation is consisting of 18 participants rotating in the following manner: Column/row A1-A6 is repositioned to column/row D13-D18, then column/row A7-A12 is repositioned to column/row D1-D6, then column/row A13-A18 is repositioned to column/row D7-D12. New participants are continuing to be placed starting after column/row D18 with ID No. 19,20,21 and so forth (See FIGS. 9-1,9-2 for schematic details). Column (E) shows the chronological positions they are occupying in the new hierarchy. Column (F) shows the residual compensation of the new hierarchy based on Table 3 calculations for this month.

In this following second month another 18 participants join the hierarchy to become 36 participants. In the same manner as last month at midnight at the end of the last day of that month the database is performing the second repositioning of all participants totaling in column (E) to become 36. This time the ⅓ rotation are consisting of 36 participants rotating in the following manner: Column/row D1-D12 is repositioned to column/row G25-G36, then column/row D13-D24 is reposition to column/row G1-G12, then column/row D25-D36 is reposition to column/row G1-G24. Just like the last repositioning the new participants are placed again at the bottom continuing after column/row G36 with ID No. 37,38, 39 and so forth in consecutive order as they enter the hierarchy (See FIGS. 10-1,10-2 for schematic details). Column (H) shows the chronological positions they are occupying in the new hierarchy. Column (I) shows the residual compensation of the new hierarchy based on Table 4 calculations for this month.

In this following third month, another 18 participants join the hierarchy to become 54 participants. In the same manner as last month at midnight at the end of the last day of that month the database is performing the third repositioning of all participants totaling in column (H) to become 54. This time the ⅓ rotation is consisting of 54 participants rotating in the following manner: Column/row G1-G18 is repositioned to column/row J37-J54, then column/row G19-G36 is repositioned to column/row J1-J18, then column/row G37-G54 is reposition to column/row J19-J36. Just like the last repositioning the new participants are placed again at the bottom continuing after column/row (J54) with ID No. 55,56, 57 and so forth in a consecutive order as they enter the hierarchy (See FIGS. 11-1,11-2 for schematic details). Column (K) shows the chronological positions they are occupying in the new hierarchy. Column (L) shows the residual compensation of the new hierarchy based on Table 5 calculations for this month. (See FIGS. 12-1,12-2 for schematic details) Table 7

Table 7 Is showing the above 4 months hierarchy and 3 repositioning progression with columns (D), (G) and (J) being sorted chronologically together with columns (F), (I) and (L) to show the overall total compensation showing in column M. We must take to consideration that the outcome would be deferent in the real world since there is no way to predict how many participants each month will join. Based on this PRMLM principle more people get compensated than the traditional MLM. To be exact 49 participants or 68% of all participants were remunerated and 23 participants or 32% of all participants were not remunerated in this example.

Table 8

Table 8 shows the same exact 4 months progression of the hierarchy with 3 tiers forced down without any rotations to take place at each month. As we can see in column (H) the compensation is favoring mostly those who are on top of the hierarchy, as it grows, remunerating fewer participants. To be exact 31 participants or 43% over 4 months have been remunerated and 41 participants or 57% were not remunerated. This is the present reality of a traditional MLM hierarchy.

### SUMMERY OF INVENTION

This invention provide a software and database processing system for a Periodic Restructuring and Repositioning Multi Level Marketing Participants Matrix Hierarchy This PRMLM software and database design system is generally written for a Multi Level Marketing (MLM) for periodic repositioning participants hierarchy in any residual compensation MLM plan hierarchy by which it restructure the matrix hierarchy of the participants (purchasing products and or a services) locations every specified set period of time such as 30, 90, 180 days or any other combination of ways. This repositioning hierarchy can be set and be determined initially to fit any desirable combination of repositioning phase. PRMLM is designed to fit any combination hierarchies of compensation MLM program plans such as 3,4,5 or 6 front line tiers forced down generations horizontally and vertically.

This PRMLM invention system can operate on existing and or new MLM programs. This invention renumber temporary the binary identification tag of the MLM participants in the matrix hierarchy and retains the date and time by which participants entered the hierarchy to achieve repositioning location in the hierarchy periodically in order to rotate their position in the hierarchy. Afterwards it continues to register new participants to the MLM adding them to the new structure of the database in the same manner by which it was determined initially until the time arrives to restructure and reposition the hierarchy again.

This PRMLM invention system executes the repositioning and restructuring matrix hierarchy automatically based upon a set period of times specified initially. This PRMLM invention system also designed to determine the criteria, by which certain participants, after attaining length of participation, enter a stage in the hierarchy that grants them “A Reposition Participation Status” (RPS) such as being part of the hierarchy for being a certain length of time. This PRMLM invention system is also capable, in certain conditions, to grant a “Wild Card Position” (WCP), which set a permanent position in the hierarchy after a specified numbers of generations have accumulated in the hierarchy.

In conclusion this PRMLM, by performing the restructuring and repositioning to a MLM hierarchy, it increases the percentage of overall participants remuneration in the long run and decreases the percentage of overall participants who do not get remunerated. Most of all, this system balances the amount of compensation of the overall MLM structure and help attract more participants, which in the long will increase the growth of companies who use this marketing medium to promote their products and or services.

1. A software and database processing system designed for a periodic restructuring and repositioning of multi level marketing participants matrix hierarchy for the multi level marketing industry (hereinafter referred as “MLM”) and for any marketing companies, which adapt the approach of remunerating its participants in such system:
a) Software, means a collection of script language written to execute a change in a database;
b) Database, means storing data on a storage medium;
c) Processing, means initializing the storage medium;
d) Processing, also means identifying participants date and time of initial registration;
e) Processing, also means repositioning participants according to their chronological entry date and time;
f) Restructuring, means rearranging locations and positions of participants in the MLM hierarchy;

2. This PRMLM system is designed and written in the common programming and scripting database languages and structure used by programmers to achieve the above desired punctuality.
This PRMLM system is designed to utilize by any computer platform or operating system, which currently operate in our computer industry.

3. The target of claim 1 is to fit any desirable combination of repositioning phase and designed to fit any combination hierarchies of compensation MLM program plans such as 3,4,5 or 6 front line tier forced down generations horizontally and vertically or any other format.
a) Tier, forced down means each participants may have under them one number of participants in their first level.
b) Hierarchy, means a multi level marketing structure of participants, which are being remunerated for introducing others directly or indirectly to become consumers of an offered product or service.

4. The target of claim 1 is to alter the present traditional MLM compensation program/system were it is presently working one way only—hierarchy downward at all times.

5. The target of claim 1 is to alter permanently the MLM structure, which presently only benefit those on top of the hierarchy in today's MLM

6. The target of claim 1 is to alter permanently the constant emphasis of recruiting efforts to benefit those on top, which are needed to maintain the structure intact or to grow on the expanse, and the efforts of those at the bottom.

7. The target of claim 1 is that This PRMLM system is designed to benefit everyone who join the program particularly those who have become affiliated prior to the specified restructuring period performed by the program.

8. The target of claim 1 the repositioning procedure is designed to perform based upon the date and time of the participants joining demarcation, chronologically ascending and descending at the time of each proceeding period.

9. The target of claim 1 this PRMLM system will reposition its participants and re-assign them to a position on the top of the hierarchy structure or down depending upon their position.

10. The target of claim 1 is that this PRMLM system keeps track of new participants entering according to their time and date entrance.

11. The target of claim 1, this PRMLM system is renumbering the entire hierarchy and prepare it for a restructuring based on a set time and structure.

12. The target of claim 1, This PRMLM system is continuing to compensate participants after repositioning.

13. The target of claim 2, This PRMLM system is not restricted to be developed by any particular scripting program language but rather is versatile to be achieved with all scripting programs available in the market and is reserving the rights to utilized all scripting languages to achieve target of claim 1.

14. The target of claim 1, the software program is designed to be able to assign a “Wild Card Position” (WCP) to any of the participant's positions in the hierarchy matrix structure to achieve desirable permanent position for certain participants who achieved a specific level of participation.

15. The target of claim 1 is design to allow all participants voluntarily and legally bind into using this PRMLM system accepting the terms and or agreement to the described in clam 1.

16. The target of claim 1 is to allow participants to jointly increase the number of participants placing them one after the other in the structure by which it was determined initially.

17. The target of claim 1 is to increase the percentage of overall participant's remuneration in the long run.

18. The target of claim 1 is to decrease the percentage of overall participants who do not get remunerated.

19. The target of claim 1 is to balance the amount of compensation of the overall MLM structure and to attract more participants, which in the long will increase the growth of companies who use this marketing medium.

20. The target of claim 1 is to attract participants to attain a Repositioning Participants Status (RPS) and eventually attain a Wild Card Position (WCP)
